(19) United States
(12) Patent Application Publication
(10) Pub. No.: US 2025/0151169 A1
(43) Pub. Date: May 8, 2025

(54) METHOD AND DEVICE FOR OPERATING A WIND TURBINE GENERATOR IN A HEATING PLANT

(71) Applicant: Wobben Properties GmbH, Aurich (DE)

(72) Inventor: Simon Schrobsdorff, Eversmeer (DE)

(73) Assignee: Wobben Properties GmbH, Aurich (DE)

(21) Appl. No.: 18/938,010

(22) Filed: Nov. 5, 2024

(30) Foreign Application Priority Data
Nov. 6, 2023 (EP) 23207849.3

(51) Int. Cl. H05B 1/02; F03D 80/60

(52) U.S. Cl. CPC H05B 1/023; F03D 80/602; H05B 1/0202; F05B 2260/64

(57) ABSTRACT

The disclosure relates to operating a wind turbine generator during heating operation that includes a rotor and a stator. The stator includes a first three-phase system with three first drivetrains and a second three-phase system with three second drivetrains. The rotor is configured to generate a magnetic field and inject an electric current into the first and second three-phase systems during a rotation with the magnetic field. The first three-phase system includes a first switch for short-circuiting the first drivetrains in a closed state and idling them in an open state. The second three-phase system includes a second switch for short-circuiting the second drivetrains in a closed state and idling them in an open state. The heating operation includes a first phase in which the first switch is switched to the closed state and the second switch is switched to the open state, or vice-versa.

### TECHNICAL FIELD

The present disclosure relates to a method for operating a wind turbine generator of a wind turbine during heating operation and a wind-turbine-generator system and a wind turbine which are set up to carry out the method.

### BACKGROUND

Wind turbines are well known. They generate electrical power from kinetic wind energy by means of a wind turbine generator, which is also referred to as a generator in the following. Such wind turbines are not constantly in use, but it may occur that they must be maintained or that there is not enough wind. This can result in longer periods of time in which the wind turbine is decommissioned. During such periods, which can also be referred to as downtimes, the wind turbine can cool down, and moisture can condense in cooled areas.

Wind turbines are exposed to the effects of weather. For this purpose, certain components of the wind turbines are hermetically sealed against the penetration of moisture. This applies, for example, to electronic parts that are housed in encapsulated cabinets. In the area of the nacelle where the generator is arranged, however, sealing against moisture is difficult to implement.

However, the generator of a wind turbine, in particular, comprises large masses, which, for example, represent areas with a great risk of moisture accumulation in the event of overnight cooling when temperatures rise the following day. Since warm air can store more moisture than cold air, warm air enriched with moisture enters the nacelle and encounters a cold generator there. The moisture then condenses on the generator and condenses into water, which can occur in large quantities.

A damp generator can be problematic if the moisture precipitates on the insulation of the electrical coils and conductors, thereby aiding in the reduction of insulating effect there. In particular, resins used in insulation absorb moisture. There is therefore a risk that, after further operation of a wind turbine generator following a longer period of downtime, earth faults will occur in the generator due to moisture that has occurred. Such earth faults can lead to damage to the generator.

From document EP 2 431 604 B1, therefore, a generator heater is already known for heating a generator after a long standstill period in order to remove moisture that has penetrated by heating the generator. The method described there involves creating a short circuit in the stator in order to generate a short-circuit current in the stator by rotating an excited rotor. The short-circuit current leads to heat development due to the resistances present in the windings. However, due to the amplitude of the short-circuit current that can be generated in this way, the heat generation during such heating operation is so low that a long heating time is necessary, which can last several hours.

This means that every time after a longer downtime, it is necessary to carry out the long-lasting heating process until the wind turbine can actually be put into normal operation in order to feed energy into a supply grid. During the time that the wind turbine generator is heated, a loss is thus incurred due to a loss of profit, as no energy can be fed into the grid. In addition, no grid services can be carried out to support the grid.

### SUMMARY

Non-limiting examples of the present invention address the problems of prior art. In particular, a way is to be found to reduce the duration of the heating operation of the wind turbine generator after a longer downtime in comparison with known solutions. In any case, an alternative to what is known from prior art is to be found.

For this purpose, the present disclosure proposes a method for operating a wind turbine generator of a wind turbine during heating operation. The wind turbine generator comprises a rotor and a stator. The stator comprises a first three-phase system with three first drivetrains, which can also be referred to as the first phases, and a second three-phase system with three second drivetrains, which can also be referred to as second phases. The rotor is set up to generate a magnetic field and to inject an electric current into the first three-phase system and the second three-phase system of the stator during a rotation. The first three-phase system preferably corresponds to a system linked from the first three drivetrains, in which the ends of each of the first drivetrains are electrically conductively connected, preferably at a star point. The second three-phase system corresponds to a system linked from the three second drivetrains, in which the ends of each of the second drivetrains are electrically connected in the star point or another star point.

Preferably, each drivetrain comprises a plurality of sub-drivetrains connected in parallel. Preferably, the stator comprises a plurality of grooves, wherein in each or at least the majority of the grooves a drivetrain or a sub-drivetrain of one of the three-phase systems is inserted, which corresponds to a different three-phase system than the three-phase system to which the drivetrains or sub-drivetrains in the adjacent grooves are assigned. In summary, it is therefore true for the majority of grooves that drivetrains or sub-drivetrains in adjacent grooves are assigned to different three-phase systems of the two three-phase systems.

In addition, the first three-phase system comprises at least one first switch for short-circuiting the first drivetrains in a closed state of the first switch and for idling the first drivetrains in an open state of the first switch. The second three-phase system also comprises a second switch for short-circuiting the second drivetrains in a closed state of the second switch and for idling the second drivetrains in an open state of the second switch.

A short-circuit of the drivetrains of a three-phase system corresponds to an electrical connection of the ends of the drivetrains of a three-phase system that are not already electrically conductively connected to each other via the star point. Idling corresponds to a state of the switch in which an electric current cannot flow from one of the ends of the drivetrains of a three-phase system that are not connected to the star point to another of the ends of the drivetrains of the three-phase system that are not connected to the star point.

In addition, the heating operation comprises a first phase. In accordance with the method, in the first phase of heating operation, the first switch is switched to the closed state, and the second switch is switched to the open state, or the first switch is switched to the open state, and the second switch is switched to the closed state.

According to the present disclosure, it was recognized that a current flowing into one of the three-phase systems through the short circuit is supplemented by a current that cannot flow into the other three-phase system when idling due to the lack of a opposing field in the other three-phase system. Furthermore, there is a quadratic relationship between the induced current and the heat output so that in the short-circuited three-phase system, a current with the quadratic amplitude of the amplitude of the current is obtained, which would occur in each of the three-phase systems if they were both short-circuited. Such an increased power loss or heat output thus results in heating up faster. By alternating short-circuiting the two three-phase systems, an overall faster warm-up process is possible.

In accordance with a first embodiment, an insulation value is determined for each of the three-phase systems, which preferably indicates an isolation of the three-phase system, in particular, the drivetrains of the three-phase system with relation to an earth potential. For example, a voltage, for example a direct voltage, for example, within a range of 300 volts, is applied between one of the drivetrains and the earth potential, and a resistance between the drivetrain and the earth potential is determined. For example, an amplitude of a current in the drivetrain is measured, which is generated by the applied voltage. If this resistance is less than a predefined threshold value, which can also be referred to as the isolation threshold, it is preferable to assume there is insufficient isolation. The isolation threshold is preferably 100 kQ. In accordance with this embodiment, in the first phase, the switch of the three-phase system is transferred to the closed state, the drivetrain of which comprises the determined insulation value, which indicates the lowest insulation level.

Preferably, the three-phase system that comprises the worst insulation is heated first. It may be possible to dispense with heating the three-phase system, which has not been heated until then, particularly if all other insulation values are above a predefined insulation threshold in the case of a further measurement. A further acceleration of the heating of the generator stator is thus possible.

In accordance with another embodiment, the first phase is carried out if or only if only one of the determined insulation values is below an isolation threshold value, i.e., the other of the two determined insulation values is at or above the isolation threshold value. Preferably, if both insulation values are below the insulation threshold, a heating operation is carried out before the first phase, in which the first switch and the second switch are switched to the closed state or remain switched on. Such a preliminary phase, which precedes the first phase, is preferably carried out for a predefined period of time or depending on the isolation value(s). After the preliminary phase, the insulation values can then be redetermined for each of the three-phase systems and the first phase can be executed if only one of the insulation values is below the isolation threshold value.

It was recognized that an open-circuit voltage in the idling three-phase system during the short circuit of the other three-phase system is very low compared to an open-circuit voltage of the three-phase systems if both three-phase systems were operated simultaneously when idling. This effect can preferably also be maximized if a predefined or suitable spatial arrangement of the drivetrains of the two three-phase systems is carried out, as will be shown in the following embodiments. The comparatively lower open-circuit voltage in the idling three-phase system is caused by the opposite field of the current flowing in the short-circuited three-phase system. By lowering the open-circuit voltage, it is possible to operate one of the three-phase systems when idling even with reduced insulation values of both three-phase systems, without the risk of a ground fault of the idling three-phase system. However, if both insulation values are below the insulation threshold value, normal heating operation is carried out without an idling three-phase system as a precautionary measure in order to completely rule out earth faults.

In accordance with another embodiment, a minimum insulation threshold is or is defined. The minimum isolation threshold is lower than the isolation threshold. For example, the isolation threshold is 100 kΩ and the minimum isolation threshold is 50 kΩ, for example. In accordance with this embodiment, the first phase is carried out if or only if one or both determined insulation values are below the insulation threshold, and both determined insulation values are above the minimum insulation threshold. Preferably, if both insulation values are below the minimum insulation threshold, a heating operation is carried out before the first phase, in which the first switch and the second switch are switched or remain switched to the closed state. This preliminary phase, which precedes the first phase, is preferably carried out for a predefined period of time or depending on the isolation value(s). After the preliminary phase, the insulation values of the two three-phase systems can then be redetermined, and the first phase can be executed if both of the insulation values are above the minimum insulation threshold.

Compared to the previous exemplary embodiment, a graduated protection against earth faults is created by providing the minimum insulation threshold value. The first phase can therefore already be carried out if the insulation values are below the insulation threshold but above the minimum insulation threshold, thus accelerating the heating process overall. The minimum insulation threshold also serves as a precaution against earth faults of idling three-phase system, which could occur if this three-phase system would comprise an insulation value below the minimum insulation threshold.

In accordance with another embodiment, the method comprises a second phase. The second phase follows the first phase. In the second phase, the first switch and the second switch are switched, i.e., they are switched from their state, which they comprise in the first phase, to the other state. Thereby, if the first switch is in a closed state in the first phase, it is transferred to the open state in the second phase, and if the second switch is in the open state in the first phase, it is transferred to the closed state in the second phase. If the first switch is in the open state in the first phase, it is transferred to the closed state in the second phase, and if the second switch is in the closed state in the first phase, it is transferred to the open state in the second phase. In the second phase, the three-phase system is used to heat the stator, which was not used for heating in the first phase. Accordingly, if the stator was heated in the first phase with the first three-phase system, in the second phase the stator is heated with the second three-phase system or vice versa.

In accordance with another embodiment, further insulation values are determined after the first phase, in particular, another insulation value for each of the three-phase systems, and the second phase is only executed if at least one of the other insulation values is below an isolation threshold, for example, 100 kΩ. This means that it is not possible to carry out the second phase if the insulation value of the system not used for heating was sufficient anyway and heating the other three-phase system in a second phase is therefore not necessary.

In accordance with another embodiment, further insulation values are determined after the first phase and, in a further phase following the first phase, the switch of the three-phase system is transferred to the closed state, which comprises the lowest insulation value. The other insulation values are preferably determined in the same way as the insulation values determined before the first phase.

In accordance with another embodiment, the moisture of the stator is determined by determining at least one moisture value and the method is only carried out if the measured moisture value is above a moisture threshold. The moisture value can be determined directly via a measuring device, such as a hygrometer. Alternatively, the moisture value is determined depending on a temperature of the stator and an air temperature in or outside the nacelle in which the stator is arranged. Preferably, the moisture value corresponds to the difference between the determined temperatures of the stator and the air. Being particularly preferred, the moisture threshold value is determined as a value so that moisture values that indicate differences between the measured temperatures and indicate a colder air temperature than a temperature of the stator are below the moisture threshold. Moisture values that indicate that the temperature of the stator is below the outside temperature of the nacelle, on the other hand, indicate a moisture value that is above the moisture threshold. Preferably, the moisture threshold value is therefore within a range of a moisture value that indicates that there is no temperature difference between the stator and the air.

By determining the moisture value and comparing the moisture value to a moisture threshold, a wind turbine can be started without heating in the event that the moisture value does not indicate moisture at the stator. The stator is therefore only heated if the moisture value indicates the probability of moisture of the stator.

In accordance with another embodiment, the first phase is executed for a duration, also known as the first duration. The duration of the first phase is determined depending on the determined insulation value, particularly the one with the lowest insulation level. Preferably, the longer the duration of the first phase, the lower the determined insulation value. In addition, or as an alternative, the duration of the first phase depends on a determined moisture value, which indicates the moisture of the stator. In addition, or as an alternative, the second phase also comprises a duration. The second phase is therefore carried out for a duration that is also known as the second duration. The duration of the second phase depends on the determined further insulation value, in particular, the one that indicates the lowest insulation level, and, in addition or alternatively, on the determined moisture value or a further moisture value, which is determined as a further moisture value after the first phase, like the moisture value before the first phase.

By specifying a variable first duration and/or a variable second duration, it is possible to choose the first phase very short in the case of only minor insulation problems due to moisture prevalent at the stator. Only in the case of very large insulation problems due to high moisture at the stator is a long duration of heating necessary.

Furthermore, the invention relates to a wind-turbine-generator system with a wind turbine generator. The wind-turbine-generator system is designed to carry out a method according to one of the above-mentioned embodiments. Thereby, the wind turbine generator comprises a rotor and a stator, wherein the stator comprises a first three-phase system with three first drivetrains and a second three-phase system with three second drivetrains. The rotor is set up to generate a magnetic field and to inject an electric current into the first three-phase system and the second three-phase system during a rotation.

The first three-phase system also comprises a first switch for short-circuiting the first drivetrains in a closed state and for idling the first drivetrains in an open state. The second three-phase system comprises at least one second switch for short-circuiting the second drivetrains in a closed state and allowing the second drivetrains to idle in an open state. The wind-turbine-generator system is set up to switch the first switch to the open state and the second switch to the closed state or the first switch to a closed state and the second switch to an open state in a first phase of a heating operation. The circuit is preferably carried out by a control system of the wind-turbine-generator system, which is set up to switch the switches.

In accordance with one embodiment of the wind-turbine-generator system, it comprises an insulation measuring device and/or a moisture measuring device. The insulation measuring device is set up to determine at least one insulation value for each of the two three-phase systems. Preferably, the insulation measuring device is set up to measure an insulation value for each of the drivetrains of the three-phase systems with relation an earth potential. Insulation values, for example, describe a resistance between the respective drivetrains and an earth potential. Insulation values are therefore preferably determined in ohms. The moisture measuring device is set up to determine the moisture of the stator, which is given in the form of moisture values. Preferably, the wind-turbine-generator system comprises a control system that is designed to determine a duration of at least the first phase depending on the insulation value or moisture value determined.

In accordance with another embodiment, each of the drivetrains of both three-phase systems comprises a plurality of sub-drivetrains connected in parallel. Preferably, each of the drivetrains comprises four sub-drivetrains connected in parallel. Preferably, each of the sub-drivetrains that are connected in parallel is arranged in different areas of the stator. With each of the sub-drivetrains, a plurality of coils connected in series are formed in the stator. Preferably, each sub-drivetrain runs through grooves of the stator assigned to it and forms a plurality of coils. The coils of a sub-drivetrain are arranged over a area of the stator so that all four parallel sub-drivetrains of a drivetrain are distributed across the entire rotation of the stator.

In accordance with another embodiment, the stator comprises a plurality of grooves and at least in the majority of the grooves or in all grooves there is a drivetrain, or a sub-drivetrain of one of the three-phase systems assigned to another three-phase system than the drivetrain or sub-drivetrains inserted in the grooves adjacent to the groove.

In accordance with another embodiment, at least one first rectifier is provided, to which the drivetrains of the first three-phase system are connected on the input side. In addition, at least one second rectifier is provided, to which the drivetrains of the second three-phase system are connected on the input side. The first rectifier and the second rectifier are each set up to convert an input voltage into a DC voltage and to output it as a DC voltage on the output side at two output potentials, which preferably form the DC voltage output. The first switch is provided in the first rectifier, and the second switch is provided in the second rectifier.

In accordance with another embodiment, the first rectifier and the second rectifier are each active rectifiers. The active rectifiers each comprise six switches, wherein the first rectifier comprises six first switches and the second rectifier comprises six second switches. The switches in the respective rectifiers connect each of the drivetrains to one of two electrical potentials that form the output or two output potentials. In the short-circuit state, all switches of the respective rectifier are closed.

In accordance with another embodiment, the first rectifier and the second rectifier are each passive rectifiers. The passive rectifiers each comprise one switch, wherein the first rectifier comprises a first switch and the second rectifier comprises a second switch. The switches are each connected between two output potentials, which preferably form the DC voltage output, in order to short-circuit them in the short-circuit state and leave them unconnected in the idling state.

In addition, the present disclosure relates to a wind turbine with a wind-turbine-generator system according to one of the aforementioned embodiments. In addition, or as an alternative, the wind turbine is equipped to carry out a method according to one of the above-mentioned embodiments.

### BRIEF DESCRIPTION OF THE DRAWINGS

Further embodiments emerge from the exemplary embodiments explained in more detail in the figures. Hereby, the figures show:

FIG. 1 illustrates a wind turbine according to some aspects of the present disclosure,

FIG. 2 illustrates a wind-turbine-generator system according to some aspects of the present disclosure,

FIG. 3 illustrates a section of a wind turbine generator stator according to some aspects of the present disclosure,

FIG. 4 illustrates an active inverter in idle mode according to some aspects of the present disclosure,

FIG. 5 a illustrates n active inverter in a short-circuit state according to some aspects of the present disclosure,

FIG. 6 illustrates a passive rectifier according to some aspects of the present disclosure,

FIG. 7 illustrates the switch position of the rectifiers in a first or second phase according to some aspects of the present disclosure, and

FIG. 8 illustrates the steps of the method according to some aspects of the present disclosure.

### DETAILED DESCRIPTION

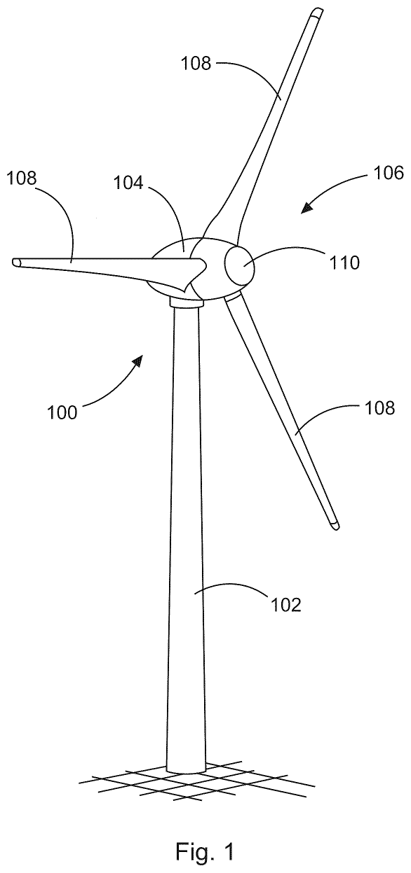

FIG. 1 shows a schematic illustration of a wind turbine 100 according to the present disclosure. The wind turbine 100 comprises a tower 102 and a nacelle 104 on the tower 102. An aerodynamic rotor 106 with three rotor blades 108 and a spinner 110 is provided for nacelle 104. During the operation of wind turbine 100, the aerodynamic rotor 106 is set in a rotational movement by the wind and thus also rotates an electrodynamic rotor or rotor of a wind turbine generator, which is directly or indirectly coupled with the aerodynamic rotor 106. The electric wind turbine generator is arranged in nacelle 104 and generates electrical energy. The pitch angles of the rotor blades 108 can be changed by pitch motors on the rotor blade roots of the respective rotor blades 108.

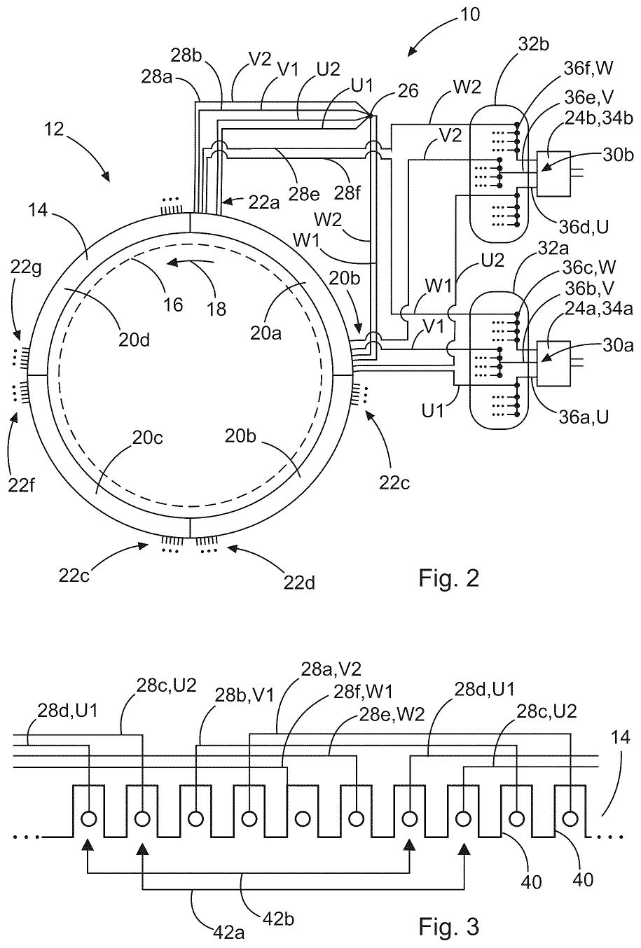

FIG. 2 shows a wind-turbine-generator system 10 which comprises a wind turbine generator 12 with a stator 14 and a rotor 16. The rotor 16 generates a magnetic field which, by rotating in the direction of rotation 18, generates a current in coils distributed over the circumference of the stator 14 and not shown in detail in FIG. 2. In the exemplary embodiment shown, the stator 14 is functionally divided into four areas 20a, 20b, 20c, 20d. Being representative of the description of the distribution of the coils, FIG. 2 shows the terminals 22a, 22b, 22c, 22d, 22e, 22f, 22g, 22h assigned to the respective area 20a, 20b, 20c, 20d, with which drivetrains or sub-drivetrains are formed that comprise the coils. The connections 22a, 22b of area 20a, representatively illustrated for all other areas 20b, 20c, 20d, are connected to rectifiers 24a, 24b as well as a star point 26. The rectifiers 24a, 24b are used to convert the current induced into the coils of the stator 14, which flows through the drivetrains with which the coils are formed to the rectifier 24a, 24b. The induced current in the three-phase systems corresponds to a three-phase alternating current, which is rectified into a direct current and is provided in normal operation at the potential outputs of the rectifiers.

Six sub-drivetrains 28a, 28b, 28c, 28d, 28e, 28f run through each area 20a, 20b, 20c, 20d of the generator from the star point 26 to the input-side connections 30a, 30b of the rectifiers 24a, 24b. The area 20a of the generator stator 14 therefore comprises two three-phase systems, namely a first three-phase system 32a, which is assigned to the rectifier 24a so that the rectifier 24a can also be described as the first rectifier 34a. In addition, a second three-phase system 32b is shown, which is assigned to the second rectifier 24b, which can therefore also be referred to as the second rectifier 34b.

The sub-drivetrains 28a, 28b, 28c, 28d, 28e, 28f are each assigned to one of the drivetrains 36a, 36b, 36c, 36d, 36e, 36f. The three-phase systems 32a, 32b each comprise three drivetrains 36a, 36b, 36c, 36d, 36e, 36f, wherein the drivetrains 36a, 36b, 36c of the first three-phase system 32a can also be described as phases U, V, W of the first three-phase system 32a. The three drivetrains 36d, 36e, 36f can also be referred to as phases U, V, W of the second three-phase system 32b.

The drivetrains 36a, 36b, 36c, 36d, 36e, 36f are each divided into four sub-drivetrains for each area 20a, 20b, 20c, 20d, wherein only the sub-drivetrains 28a, 28b, 28c, 28d, 28e, 28f are shown for better clarity. Corresponding to the drivetrains, the sub-drivetrains 28a, 28b, 28c, 28d, 28e, 28f can also be referred to as sub-phases, namely the sub-drivetrains 28b, 28d, 28f as the sub-phases U1, V1, W1 of the first three-phase system 32a and the sub-drivetrains 28a, 28c, 28e as sub-phases U2, V2, W2 of the second three-phase system 32b. For better clarity, only points are indicated for the other areas 20b, 20c, 20d the connections 22c, 22d, 22e, 22f, 22g, 22 h and for the drivetrains 36a, 36b, 36c, 36d, 36e, 36f in the area of rectifiers 24a, 24b of the correspondingly assigned sub-drivetrains. The sub-drivetrains not shown are connected with the rectifiers 24a, 24b in these areas in the same way as in the first area 20a. According to this, the four sub-drivetrains in the individual areas are connected in parallel at the rectifier to form a drivetrain.

In accordance with another exemplary embodiment not shown here, a plurality of first rectifiers 34a and a plurality of second rectifiers 34b are provided, which are connected in parallel with their input connections on the input side. Accordingly, a plurality of first rectifiers 34a are electrically connected to their input-side 30a connections and all second rectifiers 34b are electrically conductively connected to their 30b input-side connections.

FIG. 3 shows the arrangement of the sub-drivetrains 28a, 28b, 28c, 28d, 28e, 28f in grooves 40 of stator 14. It can be seen that sub-drivetrains 28a, 28b, 28c, 28d, 28e, 28f are arranged in adjacent grooves, which are assigned to different ones of the two three-phase systems 32a, 32b. For better clarity, only the sub-drivetrains 28a, 28b, 28c, 28d, 28e, 28f running in grooves 40 are shown without their winding heads. The winding heads are indicated by arrows 42a, 42b. The sub-drivetrain 28c, which runs through grooves twice, forms a coil in these two grooves and the sub-drivetrain 28d, which also runs in two grooves shown, also forms a coil.

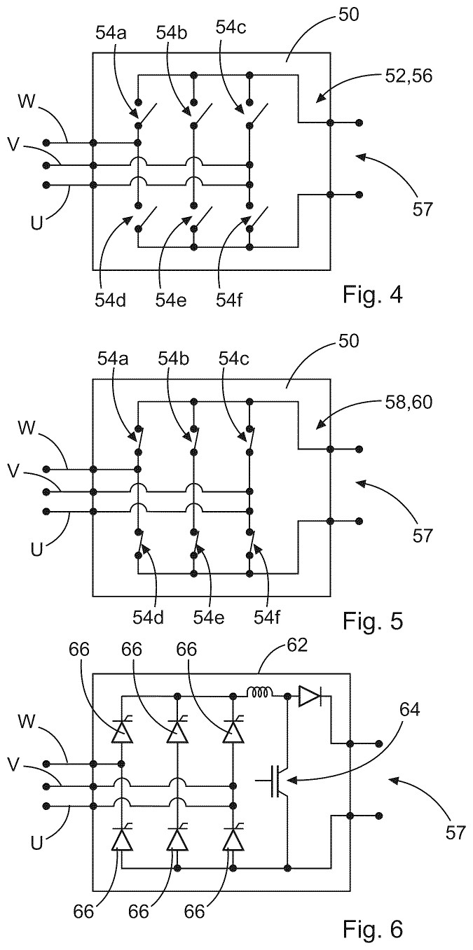

FIG. 4 shows an active rectifier 50 in an open-circuit state 52. In idle mode 52, switches 54a, 54b, 54c, 54d, 54e, 54f are open. Switches 54a, 54b, 54c, 54d, 54e, 54f are in an open state 56 to drain drivetrains 36a, 36b, 36c, 36d, 36e, 36f. Potential outputs 57, which form the DC voltage output of the rectifier 50, are thus not short-circuited, i.e., electrically isolated. The switches 54a, 54b, 54c, 54d, 54e, 54f are accordingly referred to as first switches if the active rectifier 50 corresponds to a first rectifier 34a. Accordingly, the switches 54a, 54b, 54c, 54d, 54e, 54f are referred to as second switches if the rectifier 50 corresponds to a second rectifier 34b.

FIG. 5 shows the active rectifier 50 in a short-circuit state 58, in which the switches 54a, 54b, 54c, 54d, 54e, 54f are closed. The switches 54a, 54b, 54c, 54d, 54e, 54f are thus in a closed state 60 so that the drivetrains 36a, 36b, 36c, 36d, 36e, 36f or the potential outputs 57 are short-circuited, i.e., electrically conductive.

FIG. 6 shows a passive rectifier 62 with a switch 64, which can be opened or closed in order to short-circuit or idle a voltage rectified via the thyristors 66. The switch corresponds to a first switch if the passive rectifier 62 is a first rectifier 34a, and if the passive rectifier 62 is a second rectifier 34b, a second switch.

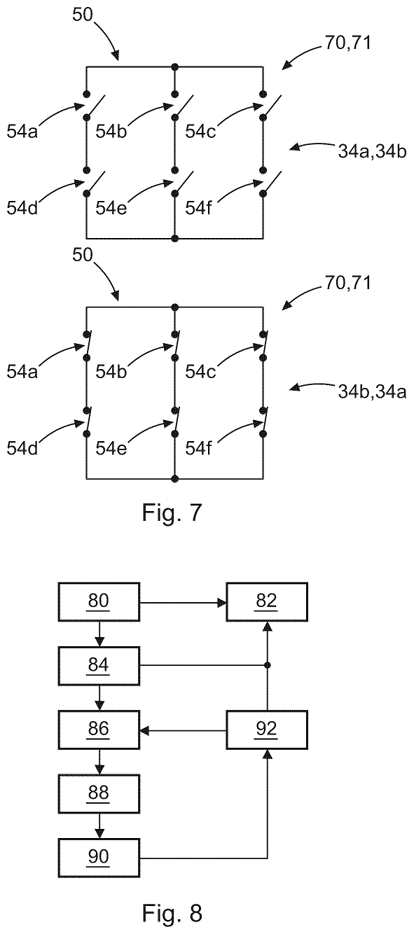

FIG. 7 shows by way of example the switch positions in a first phase 70 or in the second phase 71, wherein the upper switches 54a, 54b, 54c, 54d, 54e, 54f correspond to first switches 72a, 72b, 72c, 72d, 72e, 72f of a first rectifier 34a, which is an active rectifier 50. The lower switches 54a, 54b, 54c, 54d, 54e, 54f correspond to second switches 72b of a second rectifier 34b, which is also an active rectifier 50. It can be seen that the first switches 72a, 72b, 72c, 72d, 72e, 72f are in an open state and the second switches 72b are in a closed state.

FIG. 8 shows the steps of the method in accordance with one exemplary embodiment. In an optional step 80, a moisture of the stator is first determined by measuring a moisture value. If the moisture value is below a moisture threshold, the method is terminated at step 82. If the moisture value is above the moisture threshold or if step 80 is not present, an insulation value is determined for each of the three-phase systems 32a, 32b at step 84. At step 86, switches 54a, 54b, 54c, 54d, 54e, 54f of the three-phase system 32a, 32b are closed, which comprises a drivetrain whose insulation value is the lowest and, in particular, is below an isolation threshold. At step 88, switches 54a, 54b, 54c, 54d, 54e, 54f of the other three-phase system 32a, 32b, which, in particular, comprises an insulation value that is at or above the isolation threshold value, are opened. This first phase will run for a duration of 90. In accordance with an alternative not shown here, in the event that both isolation values are below the isolation threshold or below a minimum isolation threshold, all switches 54a, 54b, 54c, 54d, 54e, 54f of both three-phase systems 32a, 32b are closed and step 84 is not executed again until a predefined period of time has elapsed.

After the duration 90 has elapsed, further isolation values are recorded at step 92 and, if all isolation values are above an isolation threshold, the method is terminated at step 82. Otherwise, steps 86 and 88 will be performed again as the second phase. This is repeated until all insulation values are above the isolation threshold and the method is completed at step 82.

### REFERENCE LIST

10 wind-turbine-generator system
12 generator
14 stator
16 rotor
18 direction of rotation
20a-20d area
22a-22h connections
24a, 24b rectifiers
26 star point
28a-28f sub-drivetrains
30a, 30b connections
32a, 32b three-phase systems
34a, 34b rectifiers
36a-36f drivetrains
40 grooves
42a, 42b arrows
50 active rectifier
52 idle state
54a-54f switches
56 open state
57 potential outputs
58 short-circuit state
60 closed state
62 passive rectifier
64 switch
66 thyristors
70 first phase
71 second phase
72a-72f switches
80 determining the moisture of stator
82 finishing method
84 determining insulation value
86 closing switches
88 opening switches
90 first duration
92 recording additional insulation values
100 wind turbine
102 tower
104 nacelle
106 aerodynamic rotor
108 rotor blades
110 spinner
U, V, W phases
U1, V1, W1 sub-phases
U2, V2, W2 sub-phases

1. A Method for operating a wind turbine generator during a heating operation, wherein
the wind turbine generator comprises a rotor and a stator and the stator comprises a first three-phase system with three first drivetrains and a second three-phase system with three second drivetrains, wherein the rotor is configured to generate a magnetic field and to inject an electric current into the first three-phase system and the second three-phase system during a rotation with the magnetic field,
the first three-phase system comprises at least one first switch for short-circuiting the three first drivetrains in a closed state and for idling the three first drivetrains in an open state,
the second three-phase system comprises at least one second switch for short-circuiting the three second drivetrains in a closed state and for idling the three second drivetrains in an open state, and
the heating operation comprises a first phase, wherein in the first phase
a) the first switch is in the closed state and the second switch is in the open state, or
b) the first switch is switched to the open state and the second switch is switched or remains switched to the closed state.

2. The method according to claim 1, wherein the method further comprises:
determining an insulation value for each of the first three-phase system and the second three-phase system; and
in the first phase, the switch of the first three-phase system and the second three-phase system is transferred to the closed state, the insulation value of which comprises a lowest insulation level, wherein
the first phase is executed if:
the insulation value determined for the first three-phase system or the insulation value determined for the second three-phase system is below an isolation threshold, or
a minimum isolation threshold is defined and the insulation value determined for the first three-phase system and the isolation value determined for the second three-phase system are below the isolation threshold and above a minimum isolation threshold, wherein,
when the insulation value determined for the first three-phase system and the insulation value determined for the second three-phase system are below the isolation threshold, or the minimum isolation threshold is defined and the insulation value determined for the first three-phase system and the insulation value determined for the second three-phase system are below the minimum isolation threshold, a heating operation is carried out before the first phase in which the first switch and the second switch are switched or remain switched to the closed state.

3. The method according to claim 1, wherein in a second phase following the first phase, the switch opened in the first phase is closed and the switch closed in the first phase (is opened.

4. The method according to claim 3, wherein, after the first phase, at least one further respective insulation value of each of the first three-phase system and the second three-phase system is determined, and the second phase is carried out if at least one of the respective insulation values is below an isolation threshold.

5. The method according to claim 1, wherein, after the first phase, a plurality of further insulation values are determined and, in a phase following the first phase, the switch of the first three-phase system and the switch of the second three-phase system is transferred to the closed state including the lowest further insulation value.

6. The method according to claim 1, wherein
a moisture value is determined indicating a moisture of the stator, and
the method is carried out when the moisture value is above a predefined moisture threshold.

7. The method according to claim 6, wherein
the first phase comprises a first duration in which the first phase is carried out, and the first duration of the first phase depends on one or more of the determined insulation value, that includes the lowest insulation level, and the moisture value, and
the second phase comprises a second duration, in which the second phase is carried out, and the second duration of the second phase depends on one or more of the further insulation value determined that includes the lowest insulation level, and the moisture value.

8. A wind-turbine-generator system comprising a wind turbine generator, wherein the wind turbine generator comprises a rotor and a stator and the stator comprises a first three-phase system with three first drivetrains and a second three-phase system with three second drivetrains and wherein the rotor is configured to generate a magnetic field and to inject an electric current into the first one during a rotation three-phase system and the second three-phase system,
wherein the first three-phase system comprises at least one first switch for short-circuiting the first drivetrains in a closed state and for idling the first drivetrains in an open state, and
wherein the second three-phase system comprises at least one second switch (54a, 54b, 54c, 54d, 54e, 54f, 64) for short-circuiting the second drivetrains in a closed state and for allowing the second drivetrains to idle in an open state, and
wherein the wind-turbine-generator system is configured to carry out a method according to any one of the claim 1.

9. The wind-turbine-generator system according to claim 8, further comprising:
an insulation measuring device configured to determine at least one first insulation value, and at least one second insulation value,
a moisture measuring device configured to determine at least one moisture value indicating a moisture value of the stator, and
a controller configured to determine a first duration of at least the first phase as a function of one or more of the first insulation value, the second insulation value, and the moisture value.

10. The wind-turbine-generator system according to claim 8, wherein each of the three first drivetrains and the three second drivetrains comprises a plurality of parallel-connected sub-drivetrains, and each of the sub-drivetrains) is composed of a plurality of coils in the generator.

11. The wind-turbine-generator system according to claim 8, wherein the stator comprises a plurality of grooves and a drivetrain from among the three first drivetrains and the three second drivetrains or a sub-drivetrain of the first three-phase system or the second three-phase system is inserted into each or at least into a majority of the plurality of grooves, wherein the drivetrain or the sub-drivetrain is assigned to the first three-phase system and the second three-phase system other than corresponding drivetrains or corresponding sub-drivetrains arranged in grooves adjacent to the majority of the plurality of grooves).

12. The wind-turbine-generator system according to claim 8, wherein at least one first rectifier is provided, to which the three first drivetrains of the first three-phase system are connected on an input side and configured to convert one voltage on the input side into a DC voltage and output the DC voltage on an output side to two output potentials, wherein the first switch is provided in the first rectifier, and
at least one second rectifier is provided to which the three second drivetrains of the second three-phase system are connected on the input side and configured to an input voltage into a DC voltage and output the DC voltage on the output side to two output potentials, wherein the second switch is provided in the second rectifier.

13. The wind-turbine-generator system according to claim 12, wherein the first rectifier and the second rectifier are each active rectifiers and each comprise six first and six second switches respectively, wherein one of the three first drivetrains and the three second drivetrains assigned to the respective rectifier each have the two output potentials, which form the output, and are connected via one of the first switches in the first rectifier or one of the second switches (in the second rectifier.

14. The wind-turbine-generator system according to claim 12, wherein the first rectifier and the second rectifier are each passive rectifiers, and a first switch in the first rectifier is connected between the output potentials to short-circuit the output potentials in the closed state and leave the output potentials unconnected in the open state, and the second switch is connected between the output potentials in the second rectifier in order to short-circuit the output potentials in the closed state and leave the output potentials unconnected in the open state.

15. A wind turbine, wherein the wind turbine is configured to carry out the method according to claim 1.

16. A wind turbine comprising:
A wind turbine generation system according to claim 8.
